(19) United States
(12) Patent Application Publication
(10) Pub. No.: US 2014/0350977 A1
(43) Pub. Date: Nov. 27, 2014

(54) ELECTRONIC-TICKET UPDATE DEVICE, ELECTRONIC-TICKET UPDATE METHOD, ELECTRONIC-TICKET UPDATE PROGRAM, AND COMPUTER READABLE RECORDING MEDIUM CONTAINING SAID PROGRAM

(71) Applicant: Rakuten, Inc., Shinagawa-ku, Tokyo (JP)

(72) Inventor: Hideki Akashika, Shinagawa-ku (JP)

(73) Assignee: RAKUTEN, INC., Shinagawa-ku, Tokyo (JP)

(21) Appl. No.: 14/367,071

(22) PCT Filed: Dec. 26, 2012
(86) PCT No.: PCT/JP2012/083665

§ 371 Date: Jun. 19, 2014

(30) Foreign Application Priority Data
Dec. 28, 2011 (JP) 2011-288358

(51) Int. Cl. G06Q 20/06; G06Q 10/02

(52) U.S. Cl. CPC G06Q 20/065; G06Q 10/02
USPC 705/5

(57) ABSTRACT

Provided is an electronic ticket renewal device according to one embodiment that renews a validity period of an electronic ticket stored in a storage medium storing the electronic ticket and electronic money used for payment when the electronic ticket is not valid, including a specifying unit configured to compare payment information of the electronic money acquired from a storage unit with a service available by the electronic ticket, and specify a payment that would have not been made if the electronic ticket had been valid among payments made during a period from expiration of the validity period of the electronic ticket before renewal to present, and a calculation unit configured to perform processing to reduce at least part of the amount of the payment specified by the specifying unit.

### TECHNICAL FIELD

One aspect of the present invention relates to an electronic ticket renewal device, an electronic ticket renewal method, an electronic ticket renewal program, and a computer-readable recording medium storing the program.

### BACKGROUND ART

A technique of integrating a function of an electronic ticket (for example, an electronic commuter pass) whose validity period is renewable and a function of electronic money into one chip has been known. Regarding this technique, a medium processing device (ticket gate machine) that, when one function (the function of a commuter pass) of an IC card having a plurality of functions falls under constraints (expiration), can activate another function (the function of electronic money) based on a user selection is disclosed in the following Patent Literature 1. With this device, it is possible to prevent that the prepaid amount is reduced without a user's knowledge.

### CITATION LIST

### Patent Literature

PTL 1: JP 2005-316682 A

### SUMMARY OF INVENTION

### Technical Problem

However, even in the case of implementing the device disclosed in the above Patent Literature 1, a user who has the above-described IC card needs to make payment with electronic money to receive a service that could be used without payment if an electronic ticket was valid.

Accordingly, it is desirable to reduce a user's burden caused by expiration of the validity period of an electronic ticket which is renewable.

### Solution to Problem

An electronic ticket renewal device according to one aspect of the present invention is an electronic ticket renewal device that renews a validity period of an electronic ticket stored in a storage medium storing the electronic ticket with a renewable validity period and electronic money used for payment when the electronic ticket is not valid, including a specifying unit configured to compare payment information of the electronic money acquired from a storage unit with a service available by the electronic ticket, and specify a payment that would have not been made if the electronic ticket had been valid among payments made during a period from expiration of the validity period of the electronic ticket before renewal to present, and a calculation unit configured to perform processing to reduce at least part of the amount of the payment specified by the specifying unit by setting a start time of the validity period after renewal to a past point of time.

An electronic ticket renewal method according to one aspect of the present invention is an electronic ticket renewal method performed by an electronic ticket renewal device that renews a validity period of an electronic ticket stored in a storage medium storing the electronic ticket with a renewable validity period and electronic money used for payment when the electronic ticket is not valid, including a specifying step of comparing payment information of the electronic money acquired from a storage unit with a service available by the electronic ticket, and specifying a payment that would have not been made if the electronic ticket had been valid among payments made during a period from expiration of the validity period of the electronic ticket before renewal to present, and a calculation step of performing processing to reduce at least part of the amount of the payment specified in the specifying step by setting a start time of the validity period after renewal to a past point of time.

An electronic ticket renewal program according to one aspect of the present invention causes a computer to function as an electronic ticket renewal device that renews a validity period of an electronic ticket stored in a storage medium storing the electronic ticket with a renewable validity period and electronic money used for payment when the electronic ticket is not valid, the program causing the computer to implement a specifying unit configured to compare payment information of the electronic money acquired from a storage unit with a service available by the electronic ticket, and specify a payment that would have not been made if the electronic ticket had been valid among payments made during a period from expiration of the validity period of the electronic ticket before renewal to present, and a calculation unit configured to perform processing to reduce at least part of the amount of the payment specified by the specifying unit by setting a start time of the validity period after renewal to a past point of time.

A computer-readable recording medium according to one aspect of the present invention stores an electronic ticket renewal program causing a computer to function as an electronic ticket renewal device that renews a validity period of an electronic ticket stored in a storage medium storing the electronic ticket with a renewable validity period and electronic money used for payment when the electronic ticket is not valid, the electronic ticket renewal program causing the computer to implement a specifying unit configured to compare payment information of the electronic money acquired from a storage unit with a service available by the electronic ticket, and specify a payment that would have not been made if the electronic ticket had been valid among payments made during a period from expiration of the validity period of the electronic ticket before renewal to present, and a calculation unit configured to perform processing to reduce at least part of the amount of the payment specified by the specifying unit by setting a start time of the validity period after renewal to a past point of time.

According to the above aspects, a payment that would have not been made if the electronic ticket had been valid is specified among payments by the electronic money that have been made during a period from expiration of the validity period of the electronic ticket to start of the validity period after renewal. Then, by setting the start time of the validity period after renewal to a past point of time, at least part of the amount of the payment is reduced. In this manner, when renewing the validity period of the electronic ticket, the start time of the validity period is set to a past point of time in consideration of payments that would have not been made if the electronic ticket had been valid, and it is thereby possible to reduce a user's burden caused by expiration of the validity period.

In the electronic ticket renewal device according to another aspect, the specifying unit may set one or more times within a specified range after expiration of the validity period of the electronic ticket before renewal as candidate times for start of the validity period after renewal, and specify, for each of the candidate times, a payment that would have not been made if the electronic ticket had been valid after the candidate time, and the calculation unit may calculate, for each of the candidate times, a final amount to be paid to obtain the electronic ticket where the candidate time is the start time of the validity period after renewal based on the amount of the specified payment and a fee of the electronic ticket corresponding to the validity period after renewal.

In this case, because the final amount to be paid is calculated for each of a plurality of candidate times, and it is possible to reduce a user's burden caused by expiration of the validity period according to the start time of the validity period after renewal.

The electronic ticket renewal device according to another aspect may further include a presentation unit configured to present each of the candidate times and the corresponding final amount to be paid to a user requesting to renew the electronic ticket and thereby prompt the user to select one candidate time.

In this case, because a user is allowed to select the start time of the validity period after renewal, it is possible to enhance the convenience for renewal of the electronic ticket.

In the electronic ticket renewal device according to another aspect, the presentation unit may further present a fee of the electronic ticket corresponding to the validity period after renewal and a total amount of payments that would have not been made if the electronic ticket had been valid corresponding to each of the candidate times to the user.

In this case, not only the final amount to be paid but also the fee of the electronic ticket and the total amount of payments that would have not been made if the electronic ticket had been valid are displayed. It is thereby possible to present how much amount of payments by a user having been made due to expiration of the validity period of the electronic ticket is reflected on the final amount to be paid in detail to the user.

In the electronic ticket renewal device according to another aspect, the specifying unit may set the validity period after renewal so that the validity period before renewal and the validity period after renewal are successive, and specify a payment that would have not been made if the electronic ticket had been valid based on the set validity period after renewal.

In this case, because the validity period after renewal is automatically set so that there is no interval from the validity period before renewal, it is possible to reduce a user's burden caused by expiration of the validity period and save a user time and trouble to set the validity period after renewal.

In the electronic ticket renewal device according to another aspect, the specifying unit may set an earliest time of payments made during the period from expiration of the validity period before renewal to present as the start time of the validity period after renewal.

In this case, it is possible to reduce a user's burden caused by expiration of the validity period and extend the expiration date of the validity period after renewal as long as possible. It is also possible to save a user time and trouble to set the validity period after renewal.

In the electronic ticket renewal device according to another aspect, the specifying unit may set the start time of the validity period after renewal so that at least a latest time of payments made during the period from expiration of the validity period before renewal to present is included in the validity period after renewal.

In this case, it is possible to reduce at least part of a user's burden caused by expiration of the validity period and extend the expiration date of the validity period after renewal as long as possible. It is also possible to save a user time and trouble to set the validity period after renewal.

In the electronic ticket renewal device according to another aspect, the electronic ticket may be a transportation ticket, and the payment that would have not been made if the electronic ticket had been valid may be an amount corresponding to use of a section covered by the transportation ticket.

In this case, because the payment that would have not been made if the electronic ticket had been valid is specified appropriately according to the range of use, and it is thereby possible to appropriately set the final amount to be paid.

### ADVANTAGEOUS EFFECTS OF INVENTION

According to one aspect of the invention, when renewing the validity period of an electronic ticket, the start time of the validity period is set to a past point of time in consideration of payments that would have not been made if the electronic ticket had been valid, and it is thereby possible to reduce a user's burden caused by expiration of the validity period.

### BRIEF DESCRIPTION OF DRAWINGS

FIG. 1 is a diagram showing an overall configuration of a commuter pass renewal system according to an embodiment.

FIG. 2 is a diagram showing a hardware configuration of a payment terminal shown in FIG. 1.

FIG. 3 is a diagram showing a hardware configuration of a management server shown in FIG. 1.

FIG. 4 is a diagram showing an example of commuter pass information.

FIG. 5 is a diagram showing an example of use information.

FIG. 6 is a block diagram showing functional configurations of the payment terminal and the management server shown in FIG. 1.

FIG. 7(a) is a diagram showing an example of use information, and FIG. 7(b) is a route map corresponding to FIG. 7(a).

FIG. 8 is a diagram showing an example of a start date selection screen displayed on the payment terminal.

FIG. 9 is a sequence chart showing processing of the commuter pass renewal system shown in FIG. 1.

FIG. 10 is a diagram showing a configuration of a commuter pass renewal program according to an embodiment.

FIG. 11 is a block diagram showing a commuter pass renewal system according to an alternative example.

FIG. 12 is a block diagram showing a commuter pass renewal system according to another alternative example.

### DESCRIPTION OF EMBODIMENTS

Embodiments of the present invention are described hereinafter in detail with reference to the appended drawings. Note that, in the description of the drawings, the same or equivalent elements are denoted by the same reference symbols, and the redundant explanation thereof is omitted.

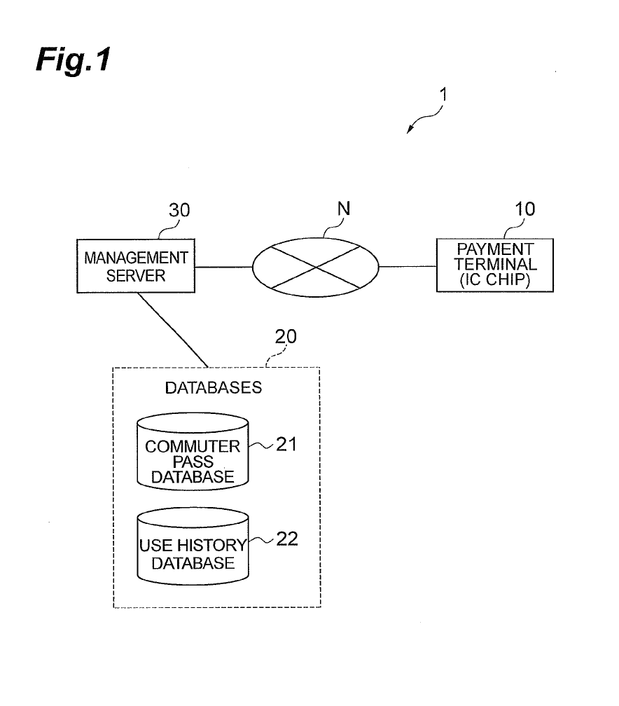

The functions and configuration of a commuter pass renewal system 1 according to an embodiment are described with reference to FIGS. 1 to 9. The commuter pass renewal system 1 is a computer system that renews a user's electronically recorded commuter pass (commuter ticket). As shown in FIG. 1, the commuter pass renewal system 1 includes a payment terminal 10 held by a user, databases 20, and a management server 30. Those devices are connected with one another through a communication network N. Although one payment terminal 10 is shown in FIG. 1, a plurality of payment terminals 10 may be included in the system.

In the commuter pass renewal system 1, the payment terminal 10 has a commuter pass function and an electronic money function. Using the payment terminal 10, the user can use specified transportation (for example, a train, a bus etc.) with the commuter pass inside the section covered by the commuter pass, and use the transportation by payment with the electronic money outside the section covered by the commuter pass. This is because a higher priority is placed on the commuter pass than on the electronic money in a ticket gate or the like. Note that the electronic money may be prepaid or postpaid (credit).

The commuter pass renewal system 1 is characterized in renewal processing (continuous purchase processing) in the case where the validity period of the commuter pass before renewal has already expired. Thus, description of continuous purchase of the commuter pass when the validity period before renewal has not yet expired is omitted, and processing of continuous purchase of the commuter pass when the validity period has once expired is described hereinafter.

The payment terminal 10 is a mobile terminal with an IC chip. The variety of the payment terminal 10 is not particularly limited, and it may be a mobile terminal such as a cellular phone, an advanced mobile phone (smart phone), or a personal digital assistant (PDA), for example.

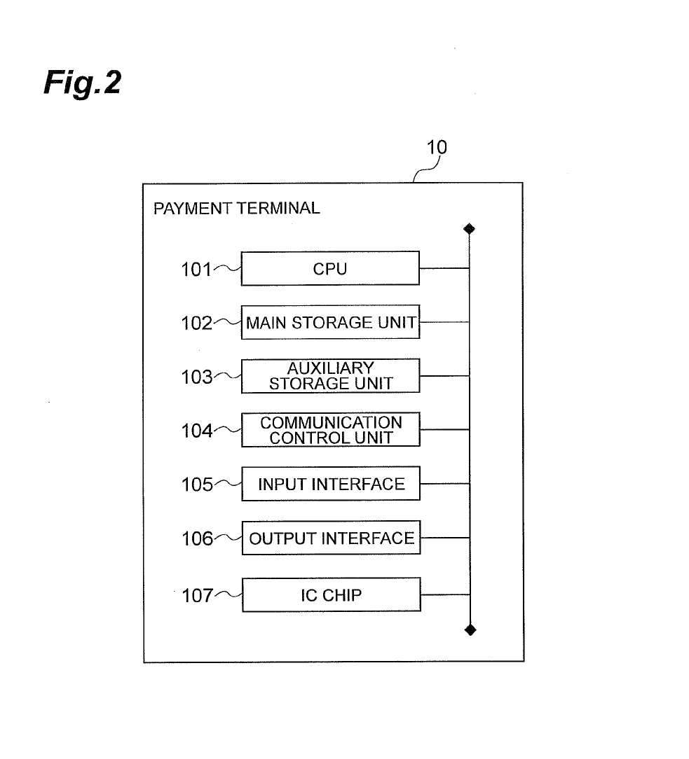

As shown in FIG. 2, the payment terminal 10 includes a CPU 101 that executes an operating system, an application program and the like, a main storage unit 102 such as ROM and RAM, an auxiliary storage unit 103 such as a flash memory, a communication control unit 104 that makes connections for communications with a mobile communication network or a wireless LAN, an input interface 105 such as a touch panel and a key, an output interface 106 such as a display and a speaker, and the IC chip 107.

The functional components of the payment terminal 10, which are described later, are implemented by loading given software onto the CPU 101 or the main storage unit 102, making the communication control unit 104, the input interface 105, the output interface 106 and the like operate under control of the CPU 101, and performing reading and writing of data in the main storage unit 102, the auxiliary storage unit 103 or the IC chip 107. The data and database required for processing are stored in the main storage unit 102, the auxiliary storage unit 103 or the IC chip 107.

The management server 30 is a computer that renews the validity period of the commuter pass electronically recorded on the payment terminal 10. In this embodiment, an electronic ticket renewal device according to the present invention is applied to the management server 30.

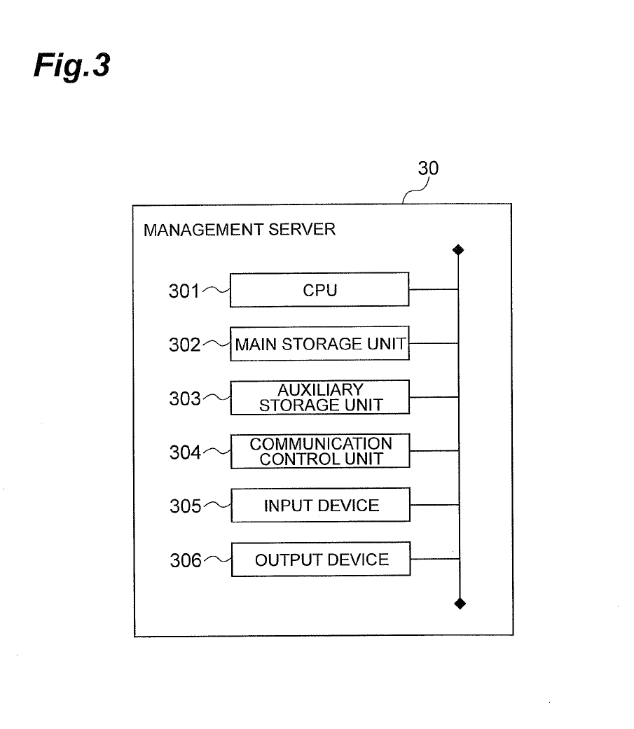

As shown in FIG. 3, the management server 30 includes a CPU 301 that executes an operating system, an application program and the like, a main storage unit 302 such as ROM and RAM, an auxiliary storage unit 303 such as a hard disk, a communication control unit 304 such as a network card, an input device 305 such as a keyboard and a mouse, and an output device 306 such as a display.

The functional components of the management server 30, which are described later, are implemented by loading given software onto the CPU 301 or the main storage unit 302, making the communication control unit 304, the input device 305, the output device 306 and the like operate under control of the CPU 301, and performing reading and writing of data in the main storage unit 302 or the auxiliary storage unit 303. The data and database required for processing are stored in the main storage unit 302 or the auxiliary storage unit 303. Although the management server 30 is composed of one computer in the example of FIG. 3, the functions of the management server 30 may be distributed among a plurality of computers.

The databases 20 are a group of databases necessary for renewal of the commuter pass. In this embodiment, the databases 20 include a commuter pass database 21 and a use history database 22.

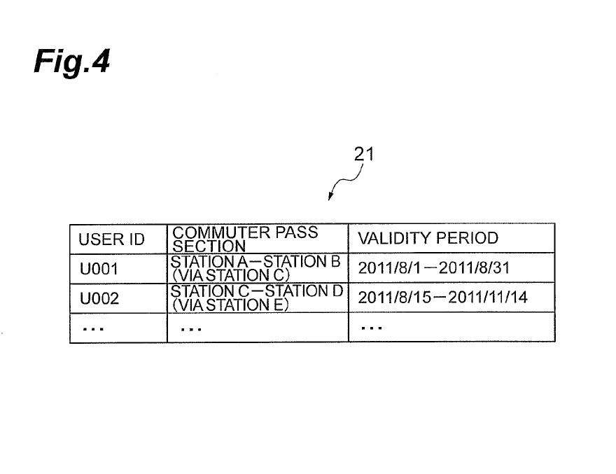

The commuter pass database 21 is a means of storing commuter pass information about the validity period of the commuter pass of each user. As shown in FIG. 4, the commuter pass information is information containing a user ID that identifies a user, the section covered by the commuter pass, and the validity period (start date and expiration date) of the commuter pass.

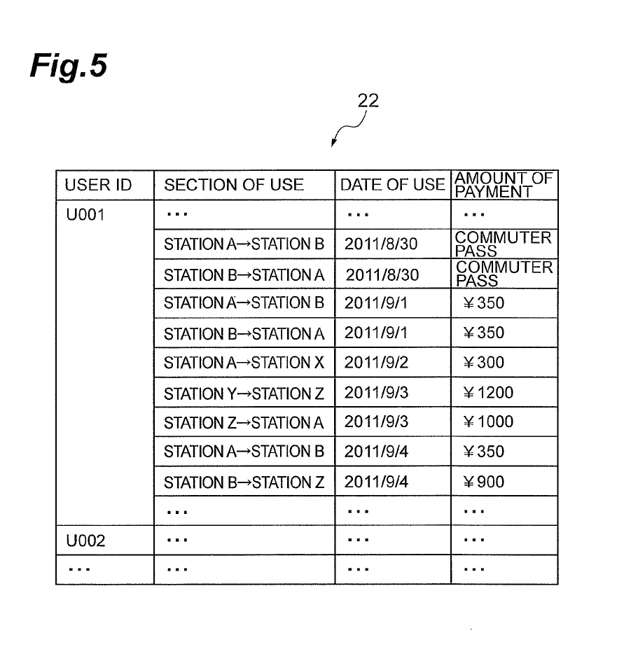

The use history database 22 is a means of storing use information (payment information), which is a record of each user riding on transportation. As shown in FIG. 5, the use information is information containing a user ID, a section of use, a date of use, and a payment amount. The payment amount is the amount paid with electronic money. The “commuter pass” in the payment amount field indicates that the commuter pass, not the electronic money, is used as a means of payment.

Note that the structures of the commuter pass database 21 (commuter pass information) and the use history database 22 (use information) are not limited to those shown in FIGS. 4 and 5, and the databases may be normalized or made redundant by an arbitrary policy.

Based on the above assumption, the functions and configuration of the payment terminal 10 and the management server 30 are described hereinafter.

The IC chip 107 of the payment terminal 10 is an electronic module composed of physical elements such as CPU, RAM, ROM and EEPROM. The IC chip 107 has a function of storing information into a storage area formed inside and a function of reading information from the storage area or rewriting information stored in the storage area according to an externally input command. For example, payment with electronic money is made by near field communication with an automatic ticket gate, a payment processing terminal or the like.

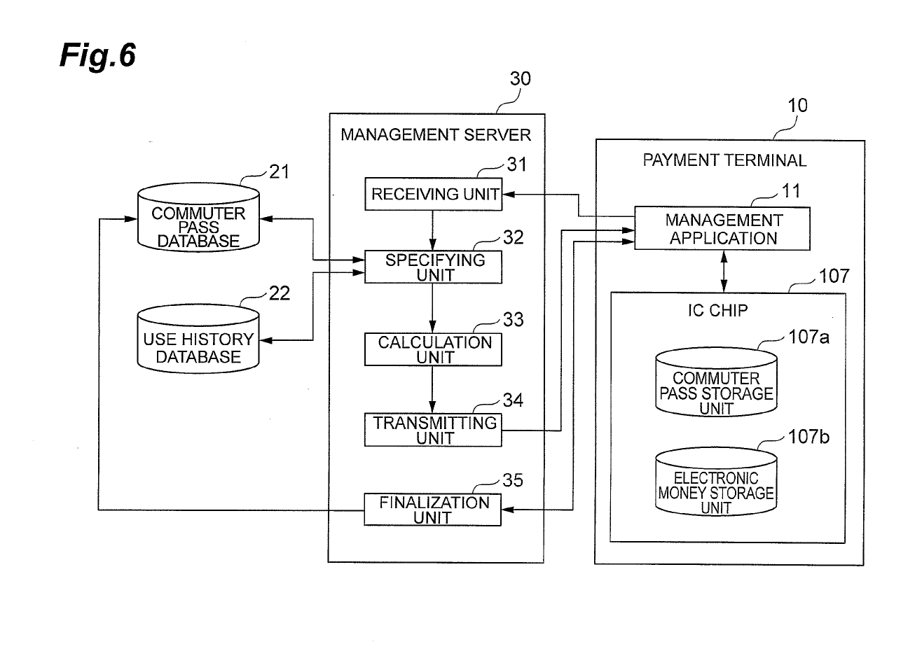

As shown in FIG. 6, the IC chip 107 of the payment terminal 10 includes two storage areas: a commuter pass storage unit 107a and an electronic money storage unit 107b. The commuter pass storage unit 107a stores the above-described commuter pass information, which contains a user, ID, a section covered by the commuter pass, and an validity period (start date and expiration date). On the other hand, the electronic money storage unit 107b stores a user ID and the balance of electronic money. Note that the electronic money storage unit 107b may store the above-described use information.

In the payment terminal 10, a management application 11 for controlling the commuter pass and the electronic money in the IC chip 107 is installed. The management application 11 is a program that controls the IC chip 107 according to an instruction signal from the management server 30, an automatic ticket gate or a payment processing terminal, or a user operation. For example, the management application 11 updates the commuter pass information (for example, the validity period) in the commuter pass storage unit 107a based on an instruction from the management server 30 or a user operation.

As the function related to communication with the management server 30, the management application 11 transmits a request (renewal request) for renewing the validity period of the commuter pass to the management server 30. After that, the management application 11 receives candidate information transmitted from the management server 30 in response to the renewal request and displays it on the payment terminal 10. The candidate information is information for selecting the start date (which is also referred to hereinafter as “next start date”) of the validity period of the commuter pass after renewal, which is described in detail later. When a user selects the next start date of the commuter pass, the management application 11 transmits information (selection notification) indicating the selected validity period after renewal and start date. After that, the management application 11 receives the updated commuter pass information transmitted from the management server 30 in response to the start date notification and updates the commuter pass information in the commuter pass storage unit 107a based on the information and thereby rewrites the validity period of the commuter pass.

On the other hand, the management server 30 includes a receiving unit 31, a specifying unit 32, a calculation unit 33, a transmitting unit (presentation unit) 14, and a finalization unit 35 as functional components.

The receiving unit 31 is a means of receiving the renewal request from the payment terminal 10. The renewal request contains a user ID stored in the commuter pass storage unit 107a of the IC chip 107. The receiving unit 31 reads the commuter pass information corresponding to the user ID from the commuter pass database 21 and outputs it to the specifying unit 32. Note that, if the renewal request contains the commuter pass information, the receiving unit 31 may output the commuter pass information to the specifying unit 32 as it is. As described above, this embodiment is based on the assumption that the validity period indicated by the commuter pass information has already expired.

The specifying unit 32 is means of specifying payments with electronic money that have been made during the period from the expiration of the validity period of the commuter pass before renewal to the start of the validity period set next (the validity period after renewal). In other words, the specifying unit 32 specifies payments that would have not been made if the commuter pass had been valid.

The specifying unit 32 determines candidates for the start date of the validity period after renewal based on the expiration date (which is also referred to hereinafter as “current expiration date”) of the validity period before renewal indicated by the commuter pass information input from the receiving unit 31. Note that the expiration of the validity period before renewal is the business close time on the expiration date (the date can be the next day), and the start time of the validity period after renewal is the business start time on the start date. For example, the specifying unit 32 sets one or more dates from the next day of the current expiration date to the renewal processing date as candidate dates. Alternatively, the specifying unit 32 may set one or more dates from the next day of the current expiration date to a future date after the renewal processing date as candidate dates. The renewal processing date is the date when the renewal processing of the commuter pass is performed by the management server 30, which can be the present date.

Then, the specifying unit 32 specifies payments that would have not been made if the commuter pass had been valid among payments with electronic money made during the period from the expiration of the validity period before renewal to the renewal processing date. Specifically, the specifying unit 32 reads the use information indicating payments during the period from the expiration of the validity period before renewal to the renewal processing date from the use history database 22. The specifying unit 32 then compares the section of use indicated by each use information with the section of use covered by the commuter pass and thereby specifies payments that would have not been made if the commuter pass had been valid after the candidate date among one or more payments indicated by the read use information. The section of use covered by the commuter pass indicates the service available with the commuter pass. Note that the amount of payment specified by the specifying unit 32 is referred to hereinafter as “commuter pass use equivalent amount”.

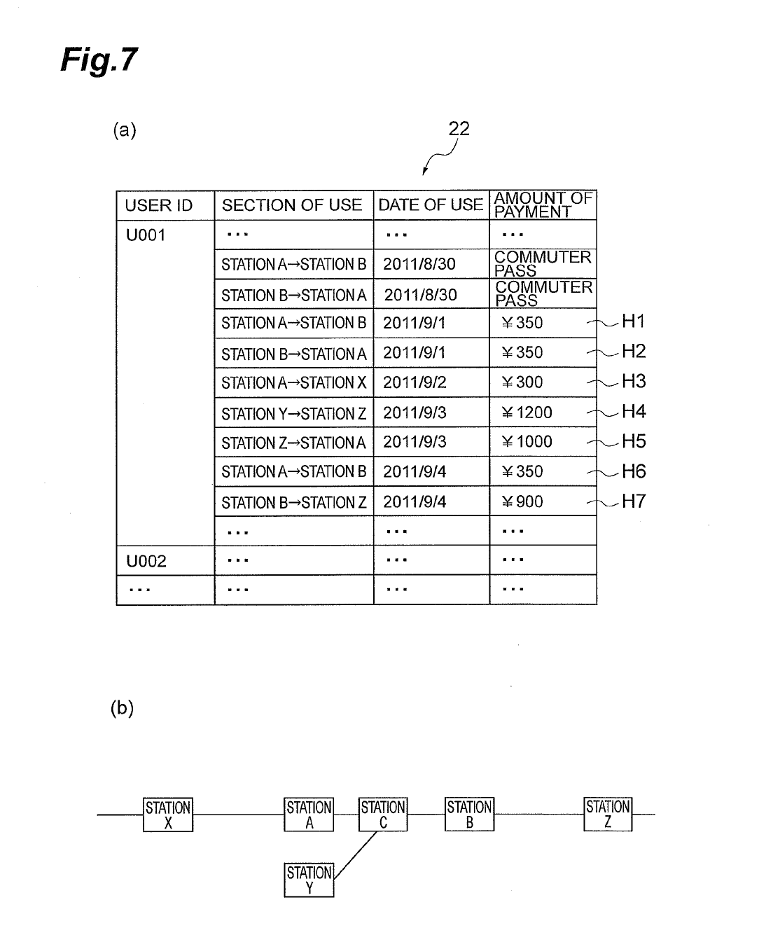

Specifying processing for a user “U001” is described with reference to FIGS. 4 and 7. Note that, the use information shown in FIG. 7(a) is the same as the one shown in FIG. 5, and for easier description, use of electronic money by the user “U001” from September 1 to September 4 is indicated as H1 to H7. Further, FIG. 7(b) is a route map corresponding to the section of use in FIG. 7(a). The current expiration date of the commuter pass held by the user “U001” is August 31 (see FIG. 4). Further, it is assumed that the renewal processing date is September 4, and the candidate dates are September 1, 2, 3, 4 and 5.

In the case where the candidate date is September 1, the payments that would have not been made if the next commuter pass had been valid are H1 (¥350), H2 (¥350), the section from the station C to the station B in H4 (¥200, for example), the section from the station B to the station A in H5 (¥350), and H6 (¥350). Thus, the specifying unit 32 calculates the commuter pass use equivalent amount corresponding to the candidate date “September 1” as 350+350+200+350+350=¥1600.

In the case where the candidate date is September 2, the payments that would have not been made if the next commuter pass had been valid are the section from the station C to the station B in H4 (¥200), the section from the station B to the station A in H5 (¥350), and H6 (¥350). Thus, the specifying unit 32 calculates the commuter pass use equivalent amount corresponding to the candidate date “September 2” as 200+350+350=¥900.

In this manner, the specifying unit 32 calculates the commuter pass use equivalent amounts corresponding to the candidate dates “September 3”, “September 4” and “September 5” as ¥900, ¥350 and ¥350, respectively. Note that, as shown in the example of September 4 and September 5, the commuter pass use equivalent amount after the renewal processing date, which is the present time, is the same.

After specifying the commuter pass use equivalent amount for each candidate date, the specifying unit 32 outputs the processing result, together with the user ID, to the calculation unit 33.

The calculation unit 33 is means of calculating the final amount to be paid by the user to obtain the validity period after renewal based on the payments (commuter pass use equivalent amounts) specified by the specifying unit 32 and the value of the commuter pass corresponding to the validity period after renewal.

First, the calculation unit 33 reads the commuter pass information corresponding to the user ID from the commuter pass database and specifies the section of use. Next, the calculation unit 33 reads the regular fee of the commuter pass corresponding to the section of use from a specified predetermined database. If there are a plurality of patterns for the validity period of the commuter pass (for example, 1 month, 3 months and 6 months), the calculation unit 33 reads the regular fee of each valid period. The database may be disposed in the management server 30 or included in the databases 20.

Then, the calculation unit 33 subtracts the commuter pass use equivalent amount from the regular fee of the commuter pass to thereby calculate the final amount to be paid to renew the commuter pass (i.e. to obtain the validity period of the commuter pass after renewal). The calculation unit 33 calculates the final amount to be paid for each combination of the valid period and the candidate date. For example, if the regular fee of the commuter pass with the validity period of 1 month is ¥8000 and the commuter pass use equivalent amount for each of the candidate dates September 1 to 5 is obtained as described above, the calculation unit 33 specifies the amount to be paid by the user for the candidate date “September 1” as 8000−1600=¥6400. Further, the calculation unit 33 specifies the amount to be paid for the candidate date “September 2” as 8000−900=¥7100.

In this manner, the calculation unit 33 performs processing of reducing the amount to be borne corresponding to the commuter pass use equivalent amount by setting the start time of the validity period after renewal to the past point of time. After calculating the final amount to be paid by the user, the calculation unit 33 outputs the calculation result to the transmitting unit 34. The calculation result contains the regular fee of the commuter pass, the commuter pass use equivalent amount and the final amount to be paid for each combination of the validity period and the candidate date.

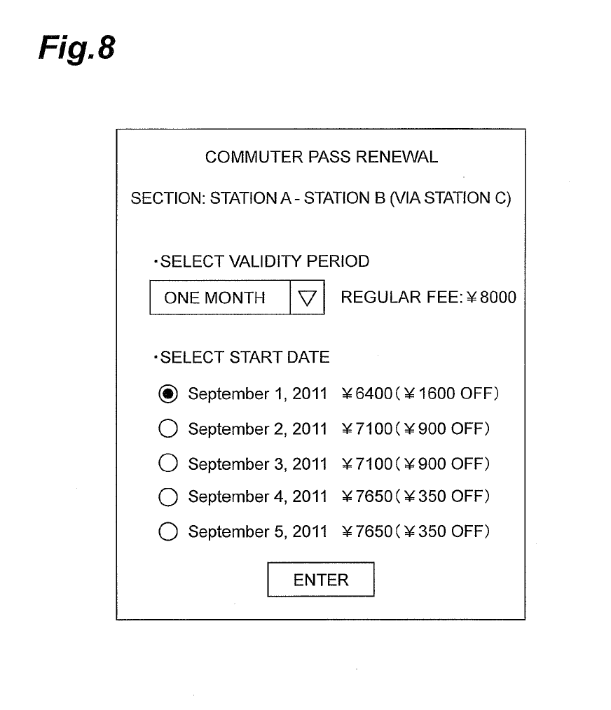

The transmitting unit 34 is a means of transmitting the calculation result input from the calculation unit 33 as candidate information to the payment terminal 10, from which the renewal request has been sent. In the payment terminal 10, the management application 11 receives the candidate information and displays it on the screen as shown in FIG. 8, for example. In this example, the validity period is selectable by a pull-down menu, and the next start date is selectable by a radio button. The corresponding regular fee is displayed next to the validity period selection field, and the final amount to be paid is displayed and further the commuter pass use equivalent amount is displayed as the amount of discount next to the next start date. When the user selects the validity period and the start date and presses the Enter button, the management application 11 sends a selection notification containing those information and the user ID to the management server 30.

Note that a method of presenting the candidate information is not limited to the one shown in FIG. 8. For example, display of the regular fee or the commuter pass use equivalent amount may be omitted.

The finalization unit 35 is a means of updating the commuter pass information stored in each of the IC chip 107 of the payment terminal 10 and the commuter pass database 21 based on the selection notification received from the payment terminal 10.

The finalization unit 35 specifies the commuter pass information corresponding to the user ID indicated by the selection notification in the commuter pass database 21 and updates the validity period (start date and end date) of the commuter pass information to the information indicated by the selection notification. Further, the finalization unit 35 transmits the updated commuter pass information to the payment terminal 10 so that the management application 11 updates the commuter pass information in the commuter pass storage unit 107a. By this processing, renewed validity period is set to the user's commuter pass.

Further, the finalization unit 35 performs payment processing for the validity period of the commuter pass after renewal (payment for continuous purchase). A method of the payment is not particularly limited. For example, if the electronic money is prepaid, the finalization unit 35 may bill the regular fee as the renewal fee of the commuter pass and recharge (pay back) the amount of discount (commuter pass use equivalent amount) to the electronic money storage unit 107b. In this case, the management application 11 updates the balance in the electronic money storage unit 107b based on an instruction from the finalization unit 35. Alternatively, if the electronic money is postpaid, the finalization unit 35 may carry out billing for the final amount to be paid in the next credit payment. In any case, in the renewal of the commuter pass, the user needs to pay only the final amount to be paid calculated by the above calculation unit 33. Note that the billing or recharging may be carried out by another server different from the management server 30, not by the finalization unit 35.

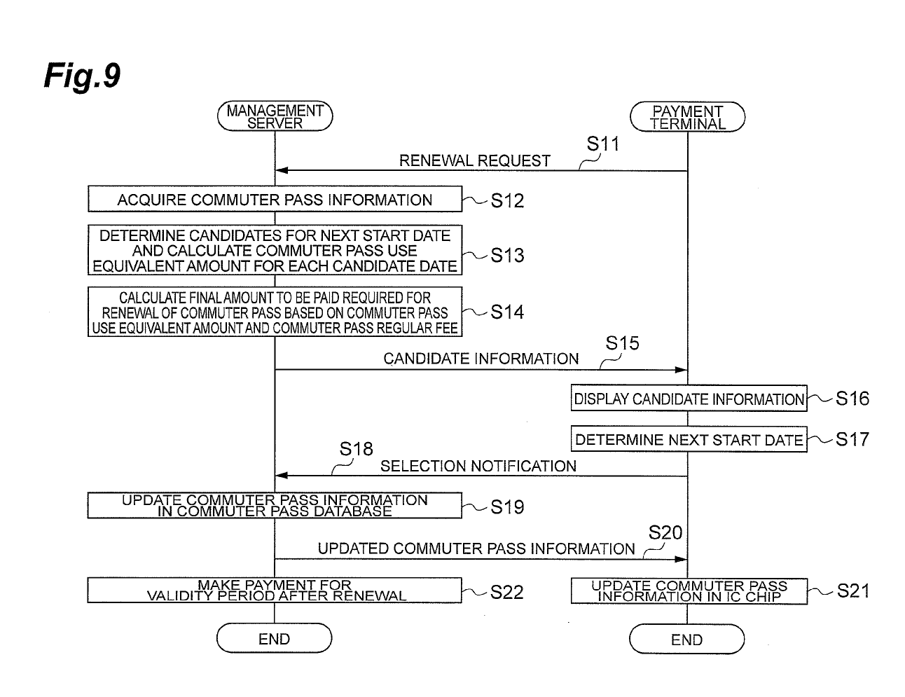

The processing in the commuter pass renewal system 1 is described and further a commuter pass renewal method (electronic ticket renewal method) according to this embodiment is described hereinafter with reference to FIG. 9.

When an operation to renew the commuter pass is performed in the payment terminal 10, the payment terminal 10 sends a renewal request to the management server 30 (Step S11). In the management server 30, the receiving unit 31 acquires the commuter pass information based on the request (Step S12).

Next, the specifying unit 32 specifies candidates for the next start date based on the commuter pass information and calculates the commuter pass use equivalent amount for each of the candidate dates (Step S13, specifying step). Specifically, the specifying unit 32 reads the use information corresponding to the period from the expiration of the validity period before renewal to the renewal processing date from the use history database 22. Then, the specifying unit 32 compares the section of use indicated by each use information with the section of use covered by the commuter pass and thereby specifies payments that would have not been made if the commuter pass had been valid after the candidate date.

Then, the calculation unit 33 calculates the final amount to be paid by the user for renewal of the commuter pass based on the commuter pass use equivalent amount and the regular fee of the commuter pass corresponding to the validity period after renewal (Step S14; calculation step). As described above, the calculation unit 33 performs this calculation for each combination of the validity period and the candidate date. After that, the transmitting unit 34 transmits the calculation result as candidate information to the payment terminal 10 (Step S15), and the management application 11 in the terminal displays the information on the screen (Step S16).

When the user enters the next start date of the commuter pass on the screen (Step S17), the management application 11 transmits the entered information as a selection notification to the management server 30 (Step S18). In the management server 30, the finalization unit 35 updates the commuter pass information in the commuter pass database 21 based on the notification (Step S19) and transmits the updated commuter pass information to the payment terminal 10 (Step S20). In the payment terminal 10, the management application 11 transfers the commuter pass information to the IC chip 107 in response to the transmission and causes the IC chip 107 to update the commuter pass information (Step S21). In addition to the update of the commuter pass information, the finalization unit 35 performs payment processing for the validity period of the commuter pass after renewal, which is payment for continuous purchase (Step S22).

By the above process, the user can renew the validity period of the commuter pass and use the commuter pass again. If the user has used the section covered by the commuter pass while the commuter pass has been invalid, the amount paid by the electronic money at the use is canceled out at the time of continuous purchase.

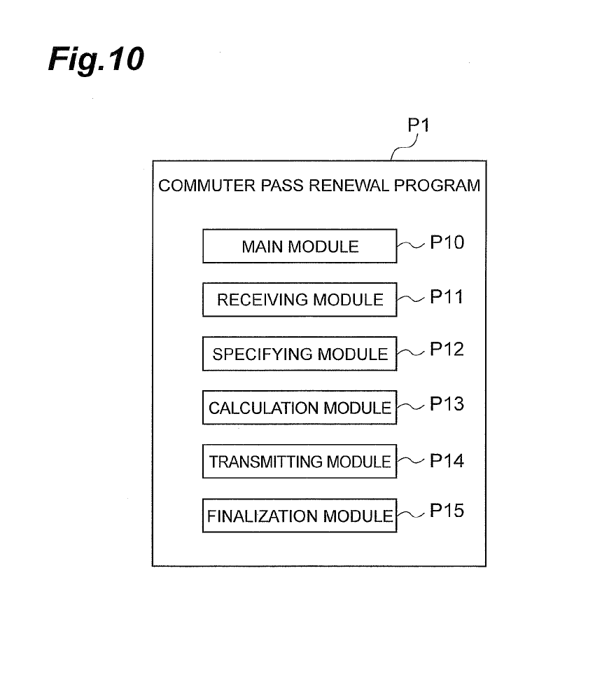

A commuter pass renewal program (electronic ticket renewal program) P1 that causes a computer to function as the management server 30 is described hereinafter with reference to FIG. 10.

The commuter pass renewal program P1 includes a main module P10, a receiving module P11, a specifying module P12, a calculation module P13, a transmitting module P14, and a finalization module P15.

The main module P10 is a part that exercises control over the commuter pass renewal function. The functions implemented by executing the receiving module P11, the specifying module P12, the calculation module P13, the transmitting module P14 and the finalization module P15 are equal to the functions of the receiving unit 31, the specifying unit 32, the calculation unit 33, the transmitting unit 34 and the finalization unit 35 described above, respectively.

The commuter pass renewal program P1 is provided in the form of being recorded in a static manner on a tangible recording medium such as CD-ROM or DVD-ROM or semiconductor memory, for example. Further, the commuter pass renewal program P1 may be provided as a data signal superimposed onto a carrier wave through a communication network.

As described above, according to this embodiment, payments that would have not been made if the commuter pass had been valid are specified among payments with electronic money made during the period from the expiration of the validity period of the commuter pass to the start of the validity period after renewal. Then, the amount to be paid by the user to make the commuter pass valid again is determined based on the payments and the fee of the commuter pass corresponding to the validity period after renewal. Thus, when renewing the validity period of the commuter pass, it is possible to calculate the amount to be paid by the user in consideration of payments that would have not been made if the commuter pass had been valid and solve the issue of payment by the user due to the expiration of the validity period.

Further, according to this embodiment, because the final amount to be paid is calculated for each of a plurality of candidate dates, it is possible to appropriately calculate the payment by a user due to the expiration of the validity period according to the start date of the validity period after renewal and solve the issue of payment.

Further, according to this embodiment, because a user is allowed to select the next start date, it is possible to enhance the convenience for renewal of the commuter pass. At this time, by displaying not only the final amount to be paid but also the regular fee of the commuter pass and the commuter pass use equivalent amount, it is possible to present the amount of payments by a user due to the expiration of the validity period which is reflected on the final amount to be paid in detail to the user.

Hereinbefore, the present invention has been described in detail with respect to the embodiment thereof. However, the present invention is not limited to the above-described embodiment. Various changes and modifications may be made therein without departing from the scope of the invention.

Although the specifying unit 32 calculates the commuter pass use equivalent amount for each of a plurality of candidate dates, and a user can select one candidate date and thereby set the start date of the validity period after renewal in the above embodiment, the specifying unit 32 may automatically set the start date.

For example, the specifying unit 32 may set the validity period after renewal so that the validity period before renewal and the validity period after renewal are successive. In the case of renewing the commuter pass of the user “U001” in the example of FIGS. 4, 5 and 7, the specifying unit 32 sets the start date of the validity period after renewal to September 1 and specifies the commuter pass use equivalent amount as ¥1600. In such a case, the validity period after renewal is automatically set so that there is no interval from the validity period before renewal, and it is thereby possible to totally solve a user's burden caused by expiration of the validity period and save the user time and trouble to set the validity period after renewal.

Alternatively, the specifying unit 32 may set the earliest payment time among payments made during the period from the expiration of the validity period before renewal to the present as the start time of the validity period after renewal. In the case of renewing the commuter pass of the user “U001” in the example of FIGS. 4, 5 and 7, the specifying unit 32 sets the date of use H1, which is September 1, as the start time of the validity period after renewal, and specifies the commuter pass use equivalent amount as ¥1600. If the uses H1 and H2 do not exist, the specifying unit 32 sets the date of use H4 including the section covered by the commuter pass (from the station C to the station B), which is September 3, and specifies the commuter pass use equivalent amount as ¥900. In such a case, it is possible to totally solve a user's burden caused by expiration of the electronic ticket and extend the expiration date of the validity period after renewal as long as possible. It is also possible to save the user time and trouble to set the validity period after renewal.

Alternatively, the specifying unit 32 may set the validity period after renewal so that at least the latest payment time among payments made during the period from the expiration of the validity period before renewal to the present is included in the validity period after renewal. In the case of renewing the commuter pass of the user “U001” in the example of FIGS. 4, 5 and 7, the specifying unit 32 sets the start date of the validity period after renewal to at least include the date of use H6, which is September 4. Thus, the specifying unit 32 may set any date from September 1 to 4 as the start date and specify the commuter pass use equivalent amount according to the set start date. In such a case, it is possible to at least partly solve a user's burden caused by expiration of the electronic ticket and extend the expiration date of the validity period after renewal as long as possible. It is also possible to save the user time and trouble to set the validity period after renewal. Note that, when setting the start date of the validity period after renewal, it may be taken into consideration whether the expiration date of the validity period after renewal is holiday or not.

Although the payment terminal 10 includes the IC chip 107 in the above embodiment, the present invention can be applied also to the case where the IC chip 107 is embedded in a smartcard 50. In this case, a user can renew the validity period of a commuter pass by inserting the card into a ticket vending machine 40 in a station or the like and performing a specified operation. In the ticket vending machine 40, a management application 41 which is similar to the one in the payment terminal 10 in the above embodiment is installed, and the management application 41 communicates with the management server 30, so that processing of continuous purchase of the commuter pass is performed in the same procedure as in the above embodiment. The information shown in FIG. 8 is displayed on the monitor of the ticket vending machine 40.

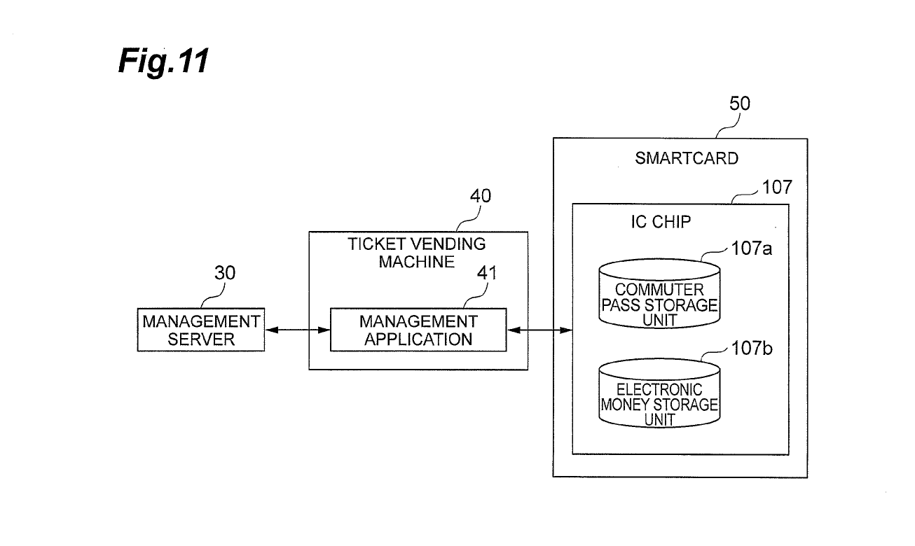

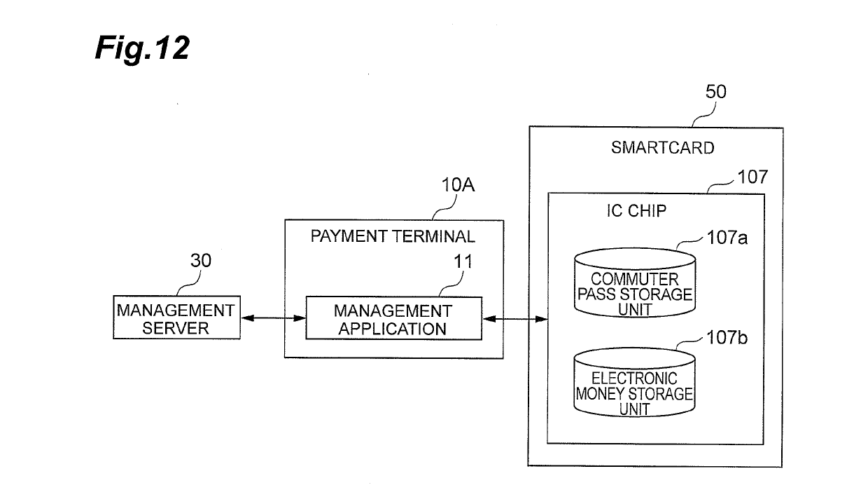

Alternatively, as shown in FIG. 12, a payment terminal 10A that can access the smartcard 50 may perform the same processing as the ticket vending machine 40 shown in FIG. 11. The management application 11 of the payment terminal 10A communicates with the management server 30 and thereby performs processing of continuous purchase of a commuter pass as in the same procedure as in the above embodiment.

Although a commuter pass is described as an example of the electronic ticket in the above embodiment, the present invention can be applied to any electronic ticket whose validity period is renewable. For example, the present invention can be applied to a free pass for public transportation, a guest ticket for facilities (a gym, a theater, a ski resort etc.) and the like.

Although the calculation unit 33 obtains the final amount to be paid by subtracting the commuter pass use equivalent amount from the regular fee of the commuter pass in the above embodiment, the calculation unit 33 may obtain the final amount to be paid by subtracting not the whole commuter pass use equivalent amount but only a part of it from the regular fee. For example, the calculation unit 33 may obtain the final amount to be paid by subtracting a specified percentage (for example, 50%) of the commuter pass use equivalent amount from the regular fee. In this case also, it is possible to reduce a user's burden caused by expiration of the validity period.

### REFERENCE SIGNS LIST

1 . . . commuter pass renewal system,
10,10A . . . payment terminal,
11 . . . management application,
20 . . . databases,
21 . . . commuter pass database,
22 . . . use history database,
30 . . . management server,
31 . . . receiving unit,
32 . . . specifying unit,
33 . . . calculation unit,
34 . . . transmitting unit,
35 . . . finalization unit,
40 . . . ticket vending machine,
41 . . . management application,
50 . . . smartcard,
107 . . . IC chip,
107a . . . commuter pass storage unit,
107b . . . electronic money storage unit,
P1 . . . commuter pass renewal program,
P10 . . . main module,
P11 . . . receiving module,
P12 . . . specifying module,
P13 . . . calculation module,
P14 . . . transmitting module,
P15 . . . finalization module

1-11. (canceled)

12. An electronic ticket renewal device that renews a validity period of an electronic ticket stored in a storage medium storing the electronic ticket with a renewable validity period and electronic money used for payment when the electronic ticket is not valid, comprising:
a candidate determination unit configured to determine a plurality of candidates for a start time of the validity period after renewal based on an expiration time of the validity period of the electronic ticket before renewal;
a specifying unit configured to compare payment information of the electronic money acquired from a storage unit with a service available by the electronic ticket, and specify a payment that would have not been made if the electronic ticket had been valid among payments made during a period from each of the plurality of candidates for the start time determined by the candidate determination unit to present; and
a display control unit configured to display each of the plurality of candidates for the start time determined by the candidate determination unit and information indicating the payment specified for each candidate by the specifying unit in association with each other on a display.

13. The electronic ticket renewal device according to claim 12, wherein
the display control unit displays a plurality of pairs of the candidate for the start time and the information indicating the payment in chronological order of the candidates for the start time.

14. The electronic ticket renewal device according to claim 12, further comprising:
an acquisition unit configured to acquire a pair selected by a user among the plurality of pairs of the candidate for the start time and the information indicating the payment displayed on the display; and
a renewal unit configured to set the candidate for the start time in the pair acquired by the acquisition unit as the start time of the validity period of the electronic ticket.

15. The electronic ticket renewal device according to claim 12, wherein
the plurality of candidates for the start time determined by the candidate determination unit include two or more candidates where the information indicating the payment specified by the specifying unit is the same.

16. An electronic ticket renewal device that renews a validity period of an electronic ticket stored in a storage medium storing the electronic ticket with a renewable validity period and electronic money used for payment when the electronic ticket is not valid, comprising:
an adjustment unit configured to compare payment information of the electronic money acquired from a storage unit with a service available by the electronic ticket, and adjust a difference between an expiration time of the validity period of the electronic ticket before renewal and a start time of the validity period of the electronic ticket after renewal.

17. The electronic ticket renewal device according to claim 16, wherein
the adjustment unit adjusts the difference so that a payment with the electronic money does not exist between the expiration time of the validity period of the electronic ticket before renewal and the start time of the validity period of the electronic ticket after renewal.

18. An electronic ticket renewal method performed by an electronic ticket renewal device that renews a validity period of an electronic ticket stored in a storage medium storing the electronic ticket with a renewable validity period and electronic money used for payment when the electronic ticket is not valid, comprising:
a candidate determination step of determining a plurality of candidates for a start time of the validity period after renewal based on an expiration time of the validity period of the electronic ticket before renewal;
a specifying step of comparing payment information of the electronic money acquired from a storage unit with a service available by the electronic ticket, and specifying a payment that would have not been made if the electronic ticket had been valid among payments made during a period from each of the plurality of candidates for the start time determined in the candidate determination step to present; and
a display control step of displaying each of the plurality of candidates for the start time determined in the candidate determination step and information indicating the payment specified for each candidate in the specifying step in association with each other on a display.

19. An electronic ticket renewal method performed by an electronic ticket renewal device that renews a validity period of an electronic ticket stored in a storage medium storing the electronic ticket with a renewable validity period and electronic money used for payment when the electronic ticket is not valid, comprising:
an adjustment step of comparing payment information of the electronic money acquired from a storage unit with a service available by the electronic ticket, and adjusting a difference between an expiration time of the validity period of the electronic ticket before renewal and a start time of the validity period of the electronic ticket after renewal.
